(19) United States
(12) Patent Application Publication
(10) Pub. No.: US 2003/0215172 A1
(43) Pub. Date: Nov. 20, 2003

(54) Fiber optic detection system and method

(76) Inventor: Greg Koenig, Golden Valley, MN (US)

Correspondence Address: MERCHANT & GOULD PC, P.O. BOX 2903, MINNEAPOLIS, MN, 55402-0903, US

(21) Appl. No.: 10/146,147

(22) Filed: May 14, 2002

(51) Int. Cl. G02B 6/26

(52) U.S. Cl. 385/15

(57) ABSTRACT

A fiber optic detection control system that comprises a light emitting device, wherein a light signal is generated and transmitted, furthermore the light signal transmission does not involve the transmission of any electrons, an optical switch device, optically coupled to the light emitting device, receives the light signal and the light signal is processed and transmitted. The optical switch device is disposed at a single switch point. The system further comprises a photodetector device is optically coupled to the optical switch device and receives the light signal, the light signal does not contain any electrical energy. Within the photodetector an electrical status signal is responsively generated and transmitted. A processing module is also included in this system and the processing module receives and processes the electrical status signal. This processing module is electrically coupled to the light emitting device and the photodetector device, and optically coupled to the optical switch device.

### TECHNICAL FIELD

The field of the invention is object detection systems, apparatus and methods therefor, in particular this invention relates to apparatus, systems and methods for detecting the presence or absence of an object within a fiber optic detecting system, and more particularly for detecting hazardous conditions.

### BACKGROUND

Detecting the open and closed state of machine access doors and gates has long been accomplished by various mechanical and magnetic interlock gate switches These two-piece interlock gate switches, which consist of a switch part and an actuator part, have been traditionally designed so that current carrying contacts of the switch are closed when the switch's actuator has been fully inserted into the switch.

Interlock Switch monitoring controllers are typically used to monitor the open and closed state of the interlock switch contacts in order to stop or otherwise control dangerous motion during machine operation and maintenance. Electrically conductive wires are used to connect prior art interlock switches to the corresponding “signal source” and “signal sense” terminals of the interlock switch-monitoring controller. If the contacts of the interlock switch are closed then the controller continuously detects or monitors its signal and will not issue a Stop command to the machine control elements.

Detecting the presence or absence of objects based upon photoelectric principles and via light transmission through fiber optic cable is also well known in the prior art. The emitter part of the sensor generates light signals that are coupled to the fiberoptic cable that sends the light signals to the inspection gap where an object will be detected. Another fiberoptic cable is coupled to the receiver of the sensor that allows the light signals to be directed back from the inspection gap to the sensor's receiver where it is detected. In this way the light is continuously being transmitted from the light source, through the fiberoptic cable, across the inspection gap, and into the receiver fiberoptic cable to the receiver. Whenever an object in the inspection gap between the two adjacent fiberoptic cables, the light signal path is blocked and the receiver detects the absence of the light signal. This mode of detection is sometimes referred to as “Dark Operate” or “Beam Break” Logic.

Currently, gate or door-monitoring applications do exist in potentially explosive environments. Such an application may involve guarding access points in a robot based, automobile body paint-booth where volatile gases are present. In these applications certain paint booth access doors may need to be monitored so that the robots or other potentially dangerous machine elements stop when these doors are opened. Machine safeguarding control elements that are approved for use in potentially explosive applications must meet special design requirements that eliminate the potential of an explosion. The requirements include special energy isolation barriers, explosion proof enclosures and special low energy circuits. Unfortunately, these additions present several problems among which are increased size, complexity, and cost of the interlock switch or guarding application. Moreover, many applications used in these potentially explosive environments use high energy signals, which serve as a source of increased danger.

In addition, there is a continuous drive to reduce the size of interlock switches to reduce the space needed for installation. Prior art interlock switches are comparatively large. Mechanical interlock switches range in volumetric size from about 90 cc to 130 cc. Magnetic interlock switches volumetric sizes range from about 15 cc to 30 cc.

Thus, it would be desirable to utilize a sensor switch that is significantly smaller than those provided by the prior art switches.

Interlock switches used for safeguarding purposes are usually designed to minimize unsafe failures. Due to the possible failure modes inherent with both mechanical and magnetic interlock switches, achieving the higher safety ratings generally requires two switches mounted on a single door or gate. Mechanical and magnetic interlock switches can also be easily defeated if a spare actuator is attached to the switch in order to close its contacts even though the door or gate it is attached to is open. The industry currently needs a switch which would reduce failure modes and could be incorporated on a door or gate with a single switch point on the door or gate, and yet maintain desirable safety ratings.

Furthermore, current interlock switches often require four wire connections per switch point (i.e., eight connections per door) in order to reach high levels of safety. It would be a further advantage if a switch, which requires only one sensor point and two signal connections to reach the highest level of safety category rating.

There is a continuous drive to reduce the size of interlock switches to reduce the space needed for installation. Prior art interlock switches are comparatively large. However, mechanical interlock switches range in volumetric size from about 90 cc to 130 cc, and magnetic interlock switches volumetric sizes range from about 15 cc to 30 cc. Furthermore, it would also be advantageous to eliminate the complex moving mechanical parts and pieces that can wear out and fail in these mechanical and magnetic switches. It would be desirable if switch could be produced that had no moving parts. Such a switch could offer a higher level of reliability and would be advantageous.

### SUMMARY

A fiber-optic detection system according to the present invention comprises a light emitter device, a first and second optical cable, an optical element, a light detector device and a controller circuit. The light emitter device, from which a light signal is generated and transmitted through the first optical cable to the optical element. The first optical cable is optically coupled to the light emitter device, within which only the light signal is transmitted. The optical element, disposed at a strategic location within a monitored zone, wherein the optical element is coupled, by the first optical cable, to the light emitter device and wherein the light signal is processed and transmitted. The second optical cable is optically coupled to the optical element, within which only the light signal is transmitted. The light detector device coupled, by the second optical cable, to the optical element device and wherein the light signal is received, and wherein further the light detector device responsively generates and transmits an electrical signal, and a controller circuit, electrically coupled to the light emitter device and the light detector device, wherein the electrical signal is processed and therefrom the controller circuit generates and transmits a status signal to an external circuitry.

Another embodiment of a fiber optic detection control system according to the present invention comprises a light emitting device, wherein a light signal is generated and transmitted, furthermore the light signal transmission does not involve the transmission of any electrons, an optical switch device, optically coupled to the light emitting device, receives the light signal and the light signal is processed and transmitted. The optical switch device is disposed at a single switch point. The system further comprises a photodetector device is optically coupled to the optical switch device and receives the light signal, the light signal does not contain any electrical energy. Within the photodetector an electrical status signal is responsively generated and transmitted. A processing module is also included in this system, and the processing module receives and processes the electrical status signal. This processing module is electrically coupled to the light emitting device and the photodetector device, and optically coupled to the optical switch device.

In yet another embodiment of an optical detection system according to the present invention comprises a light emitter means, wherein a light signal is generated and transmitted, and an optical switching means, optically coupled to the light emitter means, wherein the light signal is processed and maintained. This system also comprises the a light detector means, optically coupled to the optical switching means, wherein an electrical signal is generated as a function of the light signal, and the electrical signal is transmitted to external circuitry. The light emitter and light detector are electrically coupled. Moreover, the optical detection system has a volumetric size less than 15 cubic centimeters.

One method of detecting the presence of an object according to the present invention comprises activating an optical detection system, and transmitting a light signal, from a first location, through a predetermined area within a monitored zone. The light signal transmission does not provide for the transfer of any electron. This method also comprises collimating and maintaining the light signal at a single switching point, detecting the light signal at a second location, and processing the light signal, wherein a corresponding electrical signal is generated and transmitted at a strategic location remote from the monitored zone. This method further comprises analyzing the data contained within the corresponding electrical signal, responsively generating an electrical status signal, wherein the electrical status signal indicates the presence or absence of an object.

In another embodiment, an optical sensor system according to the present invention comprises one or more electro-optical devices, whereby each generates a separate optical signal that does not contain any electrical energy. The system further comprises at least one guarded point, where each separate optical signal is received, processed and re-transmitted, one or more optical detection devices, where the optical signal is received and a first at least one optical electrical signal is responsively generated. The first at least one optical electrical signal is then transmitted over an output line, as a function of the received optical signal, and a processor device monitors the output line and reads the electrical signal over a switching output line to determine the presence or absence of an object within the at least one guarded point.

In another embodiment of a fiber-optic detection system according to the present invention comprises a controller circuit, and a light emitter device, electrically coupled to the controller circuit. Only a light signal is transmitted, and the light signal comprises light energy and is devoid of any electrical energy. The system also includes a first optical cable which is optically coupled to the light emitter device, within which only the light signal is transmitted, and an optical element, which is disposed at a strategic location within a monitored zone. The optical element is coupled, by the first optical cable, to the light emitter device and wherein the light signal is processed and transmitted over a second optical cable. The second optical cable is optically coupled to the optical element, and only the light signal is transmitted. The system also comprises a light detector device, electrically coupled to the controller, and optically coupled to the second optical cable, from which only the light signal is received. The light detector device responsively generates and transmits an electrical signal to the controller circuit, and wherein the controller circuit processes the electrical signal, therefrom the controller circuit determines the presence or absence of an object within the monitored zone and wherein further the controller circuit generates and transmits a status signal to an external circuitry.

### BRIEF DESCRIPTION OF THE DRAWINGS

FIG. 1a illustrates a perspective view of four-channel system according to embodiment of the present invention.

FIG. 1b illustrates a detail of optical switch components according to one embodiment of the present invention.

FIG. 2 illustrates a general purpose computing system that may be used in implementing embodiments of the present invention.

FIG. 3 illustrates a perspective view of door switch application, both in an open and closed views for a possible embodiment of the present invention.

FIG. 4 illustrates a functional diagram of a controller module.

FIG. 5 illustrates a functional block diagram for processing software according to an example embodiment of the present invention.

FIG. 6 illustrates an operational flow chart of another embodiment of the invention.

### DETAILED DESCRIPTION

The present invention is a detection and control system with one or more emitting modules for generating separate detection signals intended to be transmitted through fiberoptic cable and one or more optical switch modules to one or more detection modules for generating an electronic signal, that represents the state of a guarded point based upon the presence or absence of the signal, that is monitored by a processor module which controls a switching output module.

In the case of a single channel detection and control system and a single guard point, a processing module is operatively connected to an emitter optical switch (element), a detection optical element and an output switching means, for controlling the output switching means in response to the presence or absence of a signal or in response to certain safety critical failures. An emitter generates a signal that is optically coupled to a first fiberoptic cable for signal transmission to an optical switch means for light signal collimation and through-atmosphere transmission to a second optical switch for light signal collecting, focusing and coupling to a second fiberoptic cable means for light signal transmission. This second fiberoptic cable is optically coupled to a detecting module for generating electronic signals in response to the presence or absence of the transmitted light signal. Two different electronic signal states: signal present and signal absent, correspond to the closed and open state of the monitored access point respectively.

The processing module controls the emitter and the detection modules and monitors the electronic signals generated by the detection modules to control the switching module in response to the state of the electronic signal of the detection module. The processing module also generates a series of periodic internal self-checks to ensure that the emitter module, the detection module, switching module, and other safety-critical circuit elements are operational.

The processing module, or control circuit, has memory which stores a variety of self-checking routines. Several exemplary routines include the multiple emitter channels enabled, emitter channel not enabled, and missing emitter LED pulse routines which collectively verify that the emitter channel is operative. To check the OSSD's (output safety stop device) operability, the OSSDs shorted together, OSSD shorted to +24 V DC, OSSD shorted to 0 V, OSSD over current, and OSSD excessive leakage current routines are initiated. One example as to how to check the optic channels is to run the receiver optic channel stuck on, and/or a multiple receiver optic channels at the same time routine. An EDMs (external device monitor), shorted together in one channel or two channel mode, EDMs shorted to +24 VDC, and an EDMs shorted to 0 V routine is run to verify the operability of the EDM. It can be appreciated by one skilled in the art that there are a multitude of different components and subsystems, that may be more or less complex than those discussed herein, that a specific self-check routine may be run to check and verify the operability of said components and there are a multitude of different ways to implement and initiate such routines, accordingly a discussion identifying the possible components or the routines that may need to be run to check these components need not be discussed herein.

One embodiment of the present invention has a four-channel photoelectric controller with a light emitter to provide modulated light signals that are intended to be transmitted through fiber optic cable sections and at least one sender/receiver optical switch set and a detection module for each channel. Such a multiple-channel system is desirable because many applications will need more than one optical channel. This is because many of the machines and automation cells have multiple points (doors, entryways, moving parts and similar components that require monitoring. One exemplary application where this embodiment could be utilized provides an array of beams, like a safety light curtain for use in guarding entry and exit points in robotic automobile body paint cell. The multiple-channel arrays will make sure that only car bodies go in and out of the robot.

One embodiment of the present invention provides a single controller with four separate emitter-receiver channels that can be used to monitor four or more separate gates or doors simultaneously. The processing module of the controller will cause one or more safety outputs to turn OFF in response to the absence of returned light signal from one or more of the emitter-receiver channels.

The detector module is a photodetector to receive the modulated light and an electronic circuit means to generate an electric signal in response to the returned light. The processing module is programmable computing system. In many systems, the processing module may be an embedded microprocessor-based system.

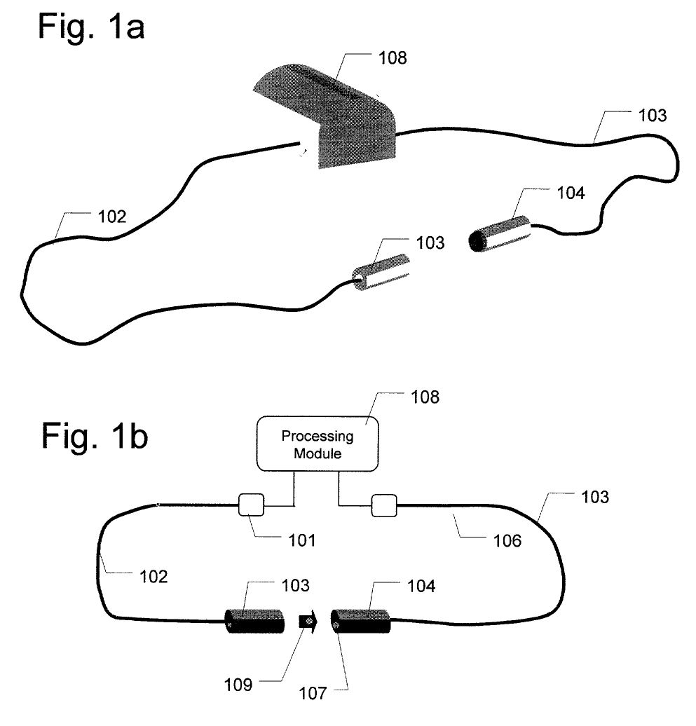

Referring to the drawings wherein the like numerals represent like components throughout the several views a photoelectric detection and control system 100 according to the present invention is illustrated generally in FIG. 1. In one embodiment disclosed and described herein a detection and control system 108 is based on fiberoptic and photoelectric components. In other words, the system incorporates one or more emitters that generate modulated light signals which are transmitted through one or more fiberoptic cables 101 to one or more optical switch component assemblies 103 that collimate the modulated light signals and transmit them to one or more optical switch assemblies 104 that collects and focuses the modulated light signals into one or more fiberoptic cables 102. These light signals are converted into electronic signals that are monitored and used to determine the state of the system outputs.

In the case of a single channel detection loop of FIG. 1B, the modulated light signals from the emitter 101 are transmitted through the first fiberoptic cable 102 and then to the first optical switch element 103 which collimates the light from the fiberoptic cable and sends it to an adjacent and second optical switch element 104 which, in-turn, focuses the light signal and couples it into the second fiberoptic cable 106 which transmits it a photodetector element 107. The adjacent optical switch elements 103 and 104 are spaced and aligned such that the light signals 113 which come from the first optical switch element 103 are directed toward and in-line with the optical axis of the aperture 105 of the second optical switch element 104 so that a sufficient quantity of the light is coupled from the first optical switch element into the second optical switch element. The light signal that reaches the photodetector elements is converted and amplified, by way of a signal amplification circuit, into an electronic signal or voltage value that is proportional to the intensity of the detected modulated light signal. A second circuit coverts the signal voltage value to a binary value (logical ON=high voltage level or logical OFF=Low voltage level) if the signal reaches or exceeds a pre-determined voltage threshold. Both amplification and threshold detection circuits are well known in the prior art.

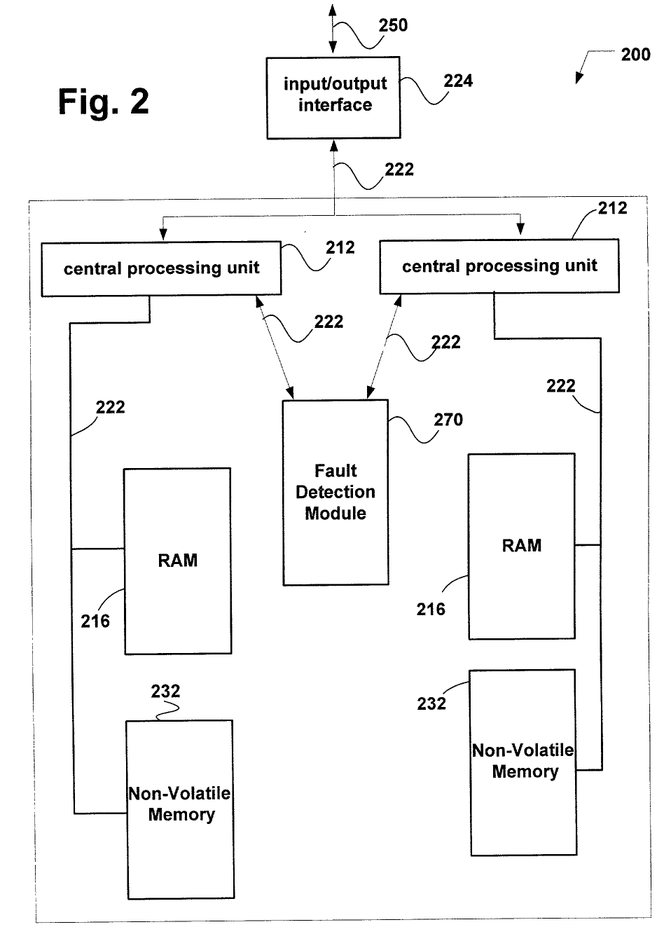

FIG. 2 illustrates an exemplary computing system that may be used in implementing embodiments of the present invention. An exemplary system 200 for implementing the invention includes a programmable computing device in the form of an embedded computing system 200, including a processor unit 212, a system memory 204, and a system bus 222 that couples various system components including the system memory 204 to the processor unit 200. The system bus 202 may be any of several types of bus structures including a memory bus or memory controller, a peripheral bus and a local bus using any of a variety of bus architectures. The system memory includes read only memory (ROM) 232 and random access memory (RAM) 216. A basic input/output interface 224 (BIOS), which contains basic routines that help transfer information between elements within the personal computer 200, is stored in ROM 232. Additional mass storage devices, and similar memory/data storage modules, in addition to ROM 232 may be present to provide data storage for computer executable program modules and programs as needed. A number of program modules may be stored on various mass storage devices, ROM 232 or RAM 216.

Generally, program modules include routines, programs, objects, components, data structures, etc. that perform particular tasks or implement particular abstract data types. Typically the functionality of the program modules may be combined or distributed in desired in various embodiments. One exemplary function of a program module or an application module according to one embodiment of the current invention, includes performing a self-test or safety monitoring functions. It can be appreciated by one skilled in the art that there are a multitude of different, more or less complex, configurations of a general purpose computing system that may have the current invention embedded within it, such that it need not be shown or discussed herein.

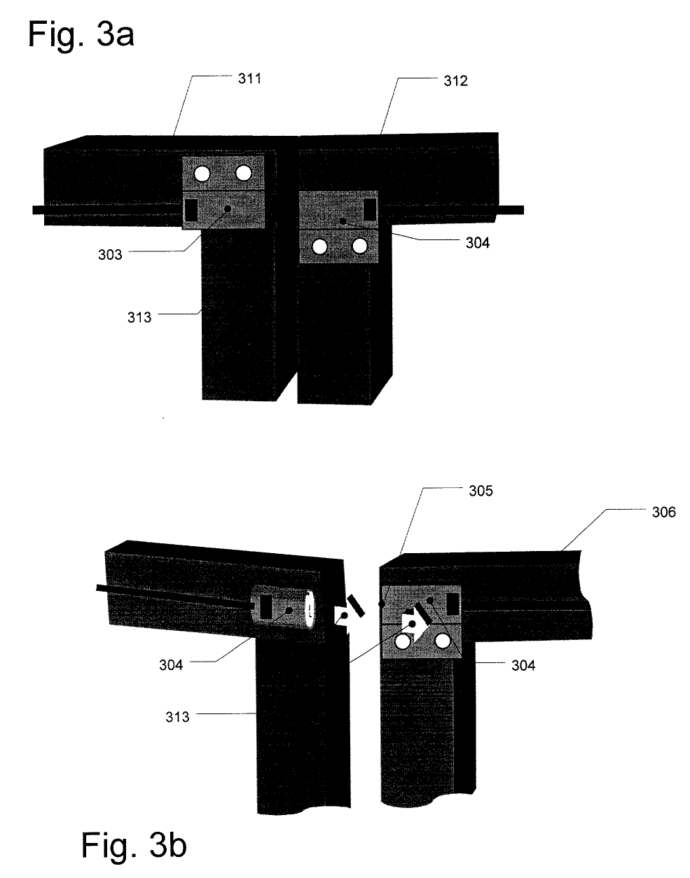

Referring to FIG. 3A, when optical switch elements 303 and 304 are fastened to a door 311 and the corresponding door frame 312 of a closed door such that they are optically aligned, the modulated light signals 313 will be transmitted from emitter optical switch element 303 to receiver optical switch element 304. During the time that the door is closed and if the modulated light signals are being generated though the optical detection loop are sufficiently intense, the photodetector circuit will detect the modulated light signals and convert them into electronic signals which will cause the voltage threshold detection circuit to turn ON.

If the door opens slightly as shown in FIG. 3B, the optical switch elements 303 and 304 will not remain optically aligned and the modulated light signals 313 will not be transmitted through the aperture 305 and coupled into the fiberoptic cable 306. The photodetector circuit will not detect these modulated light signals and convert them into electronic signal and the voltage threshold detection circuit will turn OFF.

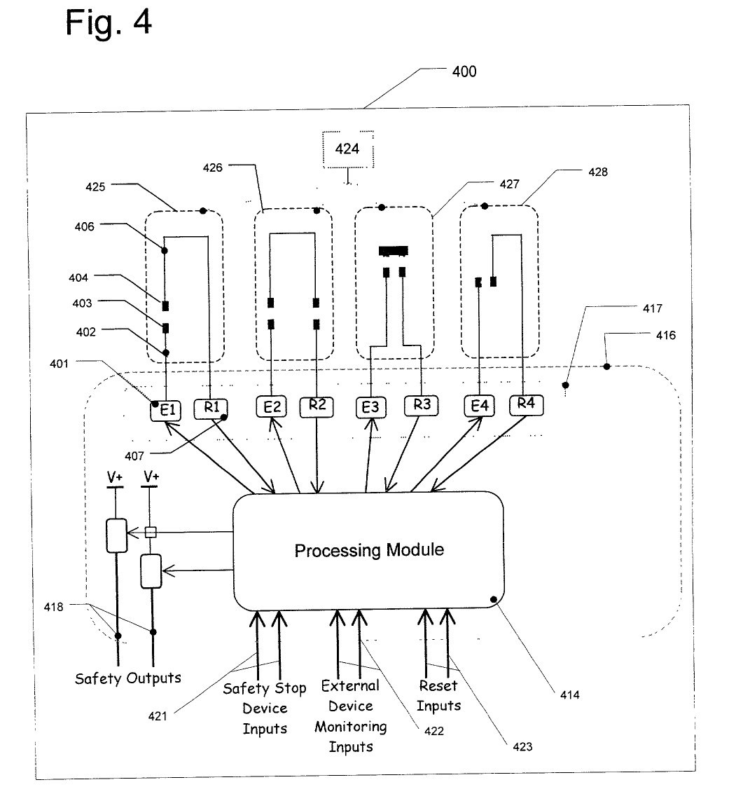

In FIG. 4, the fiberoptic detection and control system 416 includes the multiple emitter, photodetector, signal amplification and threshold detection circuits 417, the processing means 414, multiple fiberoptic detection loops 424, multiple solid state safety outputs 418, multiple safety stop inputs 421, multiple external device monitoring inputs 422 and multiple reset inputs 423.

The multiple fiber optic detection loops 424, i.e., 425, 426, 427 and 428, illustrate a variety of optical loop configurations. The first optical loop 425 contains an in-line optical switch element configuration. These lens elements collimate or focus the light signal depending on what fiber optic cable they are attached to. The direction of light signal propagation is in-line along a single transmission axis. It is either from the fiber optic cable and then through the lens (emitter side) or through the lens and into the fiber optic cable (receiver side) but the light signal never travels in any direction but inline.

The second optical loop 426 shows a serial connection where more than one switching point can be implemented in one loop. Both of these switching points show the in-line optical switch element configuration. The third loop 427 shows two in-line optical switch element configuration that are optically linked to a reflective optical switch element which contains a special type of prism. The prism accepts light signals in one aperture and reflects them out a second aperture. This reflective, or prism, optical switch element is particularly useful for applications that require the monitored door or gate be removed for machine access, maintenance, or repair. In this case, the prism optical switch element can be affixed to the removable door and the in-line optical switch elements remain on the machine. The fourth loop 428 shows a pair of right angle optical switch elements. These are optical elements that incorporate a lensed prism to transmit or reflect light at a right angle. The primary purpose for this type of optical switch element is for use where the in-line optical switch elements may not physically fit.

It can be appreciated by one skilled in the art that there are a variety of optical switch elements that can be used in the multitude of embodiments of this invention. The optical switch elements discussed herein are self-contained plug-on devices with an O-ring seal that fits around the jacket of the fiber optic cable when the fiber optic cable is inserted into the device. The O-ring forms a watertight seal that is good for many wash down applications. The optical switch elements also have an embedded snap tab which, when closed, locks the optical switch element onto the jacket. To remove the optical switch element from the fiber optic cable a small screwdriver is used to gently pry the snap tab up and the optical switch element easily unplugs.

The processing module 414 controls each emitter circuit 401 and monitors each photodetector circuit 407 to determine when each optical channel 424 should be detecting the received modulated light signals. If the processing module 414 detects that all of the threshold circuits of the photodetector circuits are turned on, the solid state safety outputs at 418 will turn on or remain on as long as all of the threshold detection circuits are on. This on state represents an acceptable light intensity level in the optical channel and corresponds to a safe condition.

If the modulated light signals are interrupted or are otherwise not sufficiently intense, the amplification circuit will not generate a voltage level that is sufficient for the threshold detection circuit to turn on. The safety outputs at 418 will turn off or remain off when the threshold detection circuit is not in the “on” state. This “off” state represents an unacceptable light intensity level in the optical channel and corresponds to an unsafe condition. The safety outputs 418 will typically be connected to and control the outputs of electromechanical relay components or safety programmable logic controllers. When the safety outputs 418 of the detection system 416 turn off, the dangerous motion will be stopped.

The detection and control system 416 allows for control reliable gate or door monitoring via photoelectric “beam break” sensing logic. The “beam-break” logic refers to a detection method that requires a constant stream of light pulses that, when interrupted for any reason, will be detected thus providing a continuous system check to ensure that the optoelectronic circuits 401 and 407 and light signal transmission lines and optical switch elements 424 are functioning. If there is a break in the fiberoptic cable 402 and 406 or another failure that causes the modulated light to not be transmitted to, or be detected by, the detection circuit, the processing means 414 will turn or keep the safety outputs 418 in the OFF state.

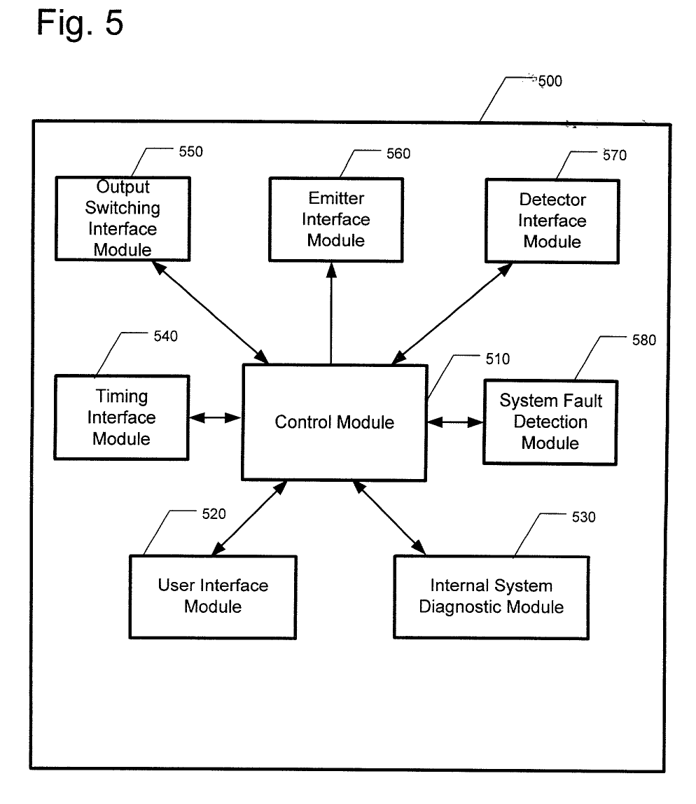

FIG. 5 illustrates a functional block diagram for processing software according to one embodiment of the present invention. The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto. Similarly, program or application modules, such as a self-test or a safety monitoring module, may also be implemented in any of such methods and means, or combinations thereof, as discussed above.

The one embodiment of a fiber-optic detection system includes a processing module 500 that includes a Control module 510, a User Interface module 520, an Internal Diagnostic module 550, an Emitter Interface module 560, a Detection Interface module 570, and an Alarm Interface module 580. The Control module 510 commands an emitter to continuously transmit low-energy, modulated light signals, via the Emitter Interface module 520. The Control module 510 manipulates the operation of the optical switching element. The optical switching element collimates and maintains the low energy light signal. The Control module 510 also controls the light detector device and, thus, activates the sensing and the corresponding electrical signal generation operation. The alarm device, prompts the alarm circuitry to transmit a signal that an object has been detected, this signal may be immediately perceivable to humans, in response to a particular signal from the Control module 510. The Control module 510 also controls the timing device, through which it ensures that the timing requirements of the system are met for proper operation. Each of these activities are achieved by communicating with the Switching Interface module 550, the Detector Interface module 570, the Alarm Interface module 580, and the Timing Interface module 540, respectively.

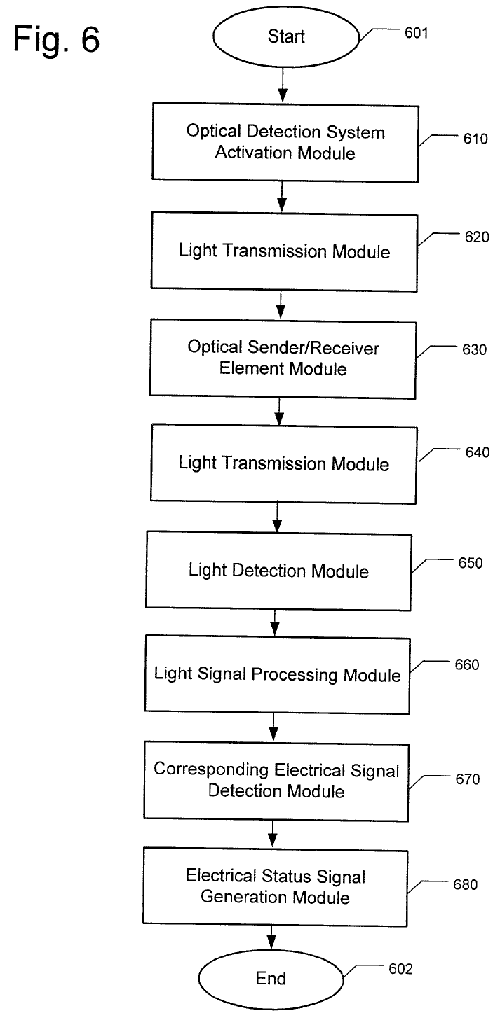

FIG. 6 illustrates an operational flow chart 600 of one embodiment of the present invention. This process is initiated at the Optical Detection System Activation module 610, prompted by a Control module. In the Light Signal Transmission module 620, the control module would cause an emitter device to begin transmitting a continuous, low-energy light signal. This light signal propagates through a first fiber optic cable network to an optical switch module, and the Light Signal Collimation and Maintenance module 630 is entered. In this module, optical switch module receives and performs various operations on the light signal. This module also provides for the light signal transmission to proceed, via a second fiber optic cable network. Within the Light Signal Detection module 640, a Light Detector module receives, or senses, the light signal over the second fiber optic cable network. The sensed light signal is processed and a corresponding electrical signal is generated and transmitted by the Light Detector module to the Light Signal Processing module 650. In one embodiment, in the Corresponding Electrical Signal Data Analysis module 660, the Control module, receives the corresponding electrical signal and performs an analysis to determine whether an object was detected in a monitored area. Based upon this analysis, the Control module, during the Electrical Status Signal Generation stage 670, drives output line with an electrical status signal to external circuitry. This signal communicates to external control circuitry whether an object is present in a monitored area.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A fiber-optic detection system, comprising:
at least one light emitter device, wherein a light signal is generated and transmitted;
at least one first optical cable is optically coupled to the at least one light emitter device, within which only the light signal is transmitted;
at least one optical element, disposed at a strategic location within a monitored zone, wherein said at least one optical element is coupled, by the first optical cable, to said at least one light emitter device and wherein the light signal is processed and transmitted;
at least one second optical cable is optically coupled to the at least one optical element, within which only the light signal is transmitted;
at least one light detector device coupled, by the at least one second optical cable, to said at least one optical element device and wherein the light signal is received, and wherein further said at least one light detector device responsively generates and transmits an electrical signal; and
a controller circuit, electrically coupled to the at least one light emitter device and the at least one light detector device, wherein the electrical signal is processed and therefrom the controller circuit generates and transmits a status signal to an external circuitry.

2. The system of claim 1, wherein said status signal comprises data that indicates the presence or absence of an object.

3. The system of claim 1, wherein said optical element comprises at least one optical switch.

4. The system of claim 1, wherein said light signal undergoes light collimation, through atmosphere transmission, light signal collecting and focusing within the optical element.

5. The system of claim 1, wherein the light signal generated by the light emitter device is a continuous, modulated light signal.

6. The system of claim 1, wherein said system has no moving parts.

7. The system of claim 1, wherein the control circuit further performs at least one internal self-check of the light emitter device, the optical element and the light detector device.

8. The system of claim 1, wherein the optical element comprises a single sensor point, wherein further the single sensor point comprises at least one sender optical switch and one receiver optical switch.

9. The system of claim 1, the optical element is less than 15 cubic centimeters in volumetric size.

10. The system of claim 1, wherein the transmission of electrons only occurs between the controller-circuit, the light detector and the light emitter device.

11. A fiber optic detection control system, comprising:
a light emitting device, wherein a light signal is generated and transmitted, wherein further the light signal transmission does not involve the transmission of any electrons;
an optical switch device, optically coupled to the light emitting device, receives the light signal and wherein said light signal is processed and transmitted, wherein said optical switch device is disposed at a single switch point; and
a photodetector device is optically coupled to the optical switch device and receives the light signal, wherein the light signal does not contain any electrical energy, and wherein further an electrical status signal is responsively generated and transmitted;
a processing module wherein said electrical status signal is received and processed;
wherein said processing module is electrically coupled to the light emitting device and the photodetector device, and optically coupled to the optical switch device.

12. The system of claim 11, wherein said electrical status signal comprises data that indicates the presence or absence of an object.

13. The system of claim 11, wherein said system has no moving parts.

14. The system of claim 11, wherein said light signal undergoes light collimation, through atmosphere transmission, light signal collecting and focusing within the optical switch device.

15. The system of claim 11, wherein the light signal generated by the light emitting device is a continuous, modulated light signal.

16. The system of claim 11, wherein the processing circuitry further performs at least one internal self-check of the light emitting device, the optical switch device and the photodetector device.

17. The system of claim 11, the optical switch device is less than 15 cubic centimeters in volumetric size.

18. An optical detection system, comprising:
an light emitter means wherein a light signal is generated and transmitted;
an optical switching means, optically coupled to said light emitter means, wherein said light signal is processed and maintained; and
a light detector means, optically coupled to said optical switching means, wherein an electrical signal is generated as a function of said light signal, and said electrical signal is transmitted to external circuitry;
wherein said light emitter and light detector are electrically coupled;
wherein further said optical detection system has a volumetric size less than 15 cubic centimeters.

19. The system of claim 18, wherein said electrical signal comprises data that indicates the presence or absence of an object.

20. The system of claim 18, wherein said optical switching means comprises at least one optical switch.

21. The system of claim 18, wherein said light signal undergoes light collimation, through atmosphere transmission, light signal collecting and focusing within the optical switching means.

22. The system of claim 18, wherein the light signal generated by the light emitter means is a continuous modulated light signal.

23. The system of claim 18, wherein the light detector means further performs at least one internal self-check of the light emitter means and the optical switching means.

24. A method of detecting the presence of an object comprising:
activating an optical detection system;
transmitting a light signal, from a first location, through a predetermined area within a monitored zone, wherein said light signal transmission does not provide for the transfer of any electron;
collimating and maintaining the light signal at a single switching point;
detecting the light signal at a second location;
processing the light signal, wherein a corresponding electrical signal is generated and transmitted at a strategic location remote from said monitored zone;
analyzing the data contained within said corresponding electrical signal; and
responsively generating an electrical status signal, wherein said electrical status signal indicates the presence or absence of an object.

25. The method of claim 24, wherein the transmitting the light signal includes generating said light signal in a continuous, and modulated manner.

26. The method of claim 24, wherein detecting the light signal involves utilizing a photodetector.

27. The method of claim 24, wherein collimating and maintaining the light signal at a single switching point utilizes a single sensor point that comprises at least one sender optical switch and one receiver optical switch.

28. An optical sensor system, comprising:
one or more electro-optical devices, whereby each generates a separate optical signal, wherein said optical signal does not contain any electrical energy;
at least one guarded point, wherein each separate optical signal is received, processed and re-transmitted;
one or more optical detection devices, wherein the optical signal is received and wherefrom a first at least one optical electrical signal is responsively generated and transmitted over an output line, as a function of the received optical signal; and
a processor device monitors the output line and reads the electrical signal over a switching output line to determine the presence or absence of an object within said at least one guarded point.

29. The optical sensor system of claim 28, wherein all transmissions of electrical energy occur at strategic location, remote from the at least one guarded point.

30. The system of claim 28, wherein said light signal undergoes light collimation, through atmosphere transmission, light signal collecting and focusing within the optical element.

31. The system of claim 28, wherein the light signal generated by the light emitter device is a continuous, modulated light signal.

32. The system of claim 28, wherein said system has no moving parts.

33. The system of claim 28, wherein the control circuit further performs at least one internal self-check of the light emitter device, the optical element and the light detector device.

34. A fiber-optic detection system, comprising:
a controller circuit;
a light emitter device, electrically coupled to said controller circuit, wherefrom only a light signal is transmitted, wherein said light signal comprises light energy and is devoid of any electrical energy;
a first optical cable is optically coupled to the light emitter device, within which only the light signal is transmitted;
an optical element, disposed at a strategic location within a monitored zone, wherein said optical element is coupled, by the first optical cable, to said light emitter device and wherein the light signal is processed and transmitted;
a second optical cable is optically coupled to the optical element, within which only the light signal is transmitted; and
a light detector device, electrically coupled to said controller, and optically coupled to said second optical cable, whereby only said light signal is received and wherein further said light detector device responsively generates and transmits an electrical signal to said controller circuit;
wherein the controller circuit processes said electrical signal, therefrom said controller circuit determines the presence or absence of an object within the monitored zone and wherein further the controller circuit generates and transmits a status signal to an external circuitry.

35. The system of claim 34, wherein said light signal undergoes light collimation, through atmosphere transmission, light signal collecting and focusing within the optical element.

36. The system of claim 34, wherein the light signal generated by the light emitter device is a continuous, modulated light signal.

37. The system of claim 34, wherein said system has no moving parts.

38. The system of claim 34, wherein the control circuit further performs at least one internal self-check of the light emitter device, the optical element and the light detector device.
